(19) United States
(12) Patent Application Publication
(10) Pub. No.: US 2008/0185198 A1
(43) Pub. Date: Aug. 7, 2008

(54) Next generation hybrid III parallel/series hybrid system

(76) Inventor: Steven Mark Jones, Mason, NH (US)

Correspondence Address: Steven Mark Jones, 346 Old Ashby Road, Mason, NH, 03048, US

(21) Appl. No.: 12/012,242

(22) Filed: Feb. 1, 2008

Related U.S. Application Data
(60) Provisional application No. 60/899,190, filed on Feb. 2, 2007.

(51) Int. Cl. B60K 6/00

(52) U.S. Cl. 180/65.2

(57) ABSTRACT

This Next Generation Heavy Hybrid Propulsion System III was specifically designed to use mainly all off the components. This facilitates in the rapid deployment to market with minimum increased purchasing price to the truck over conventional propulsion systems.

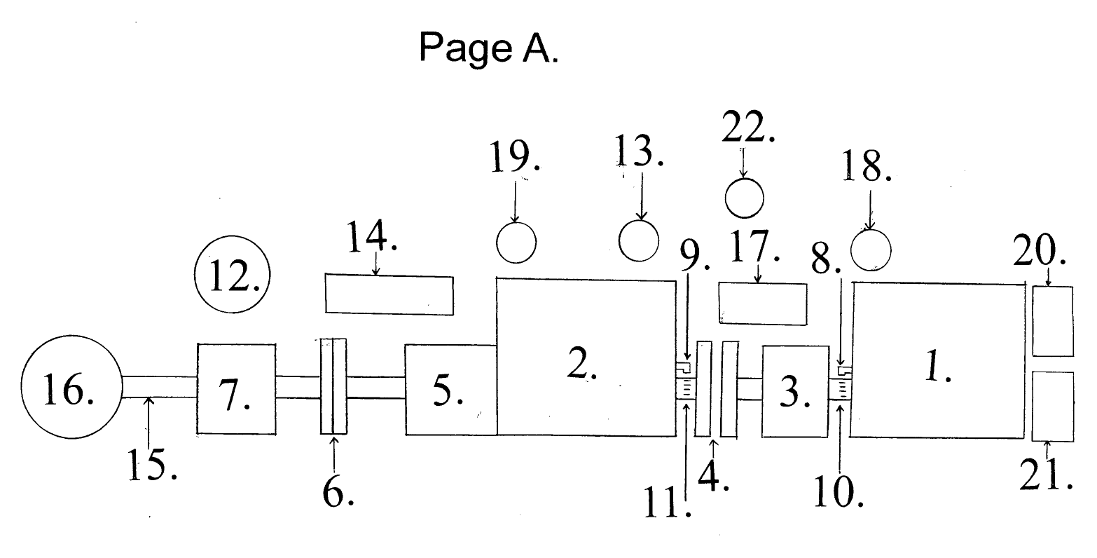

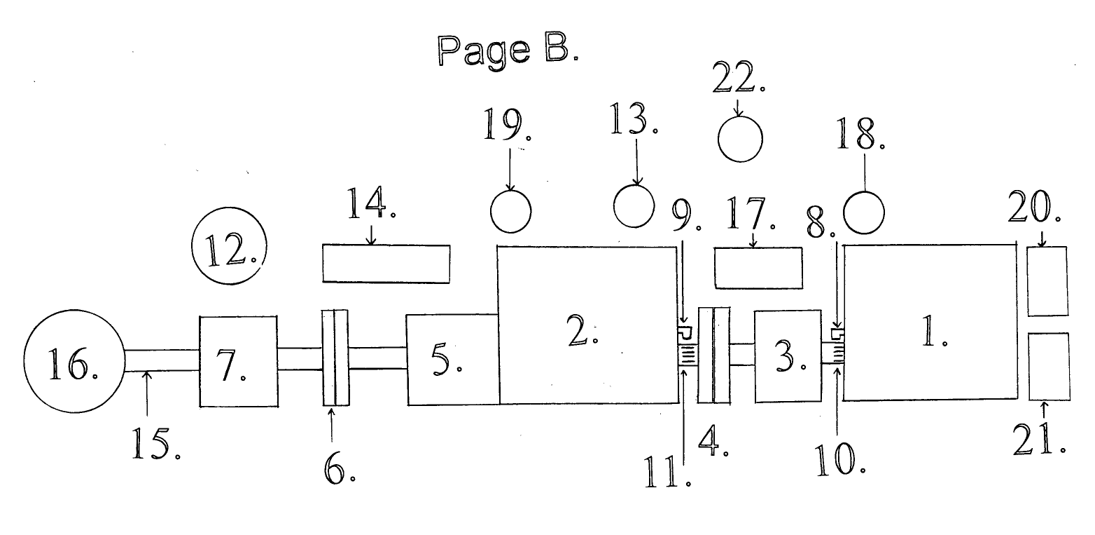

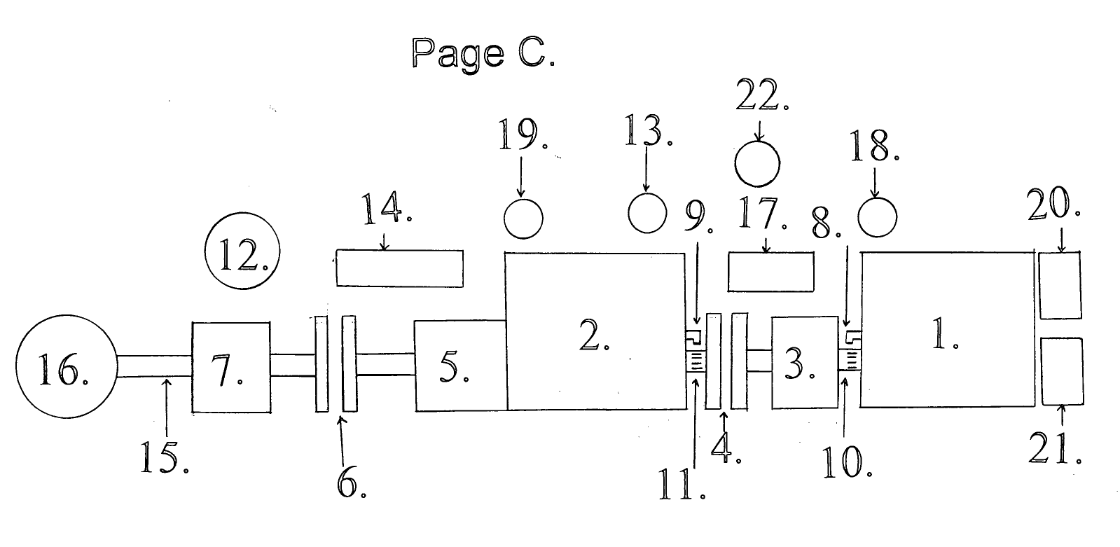

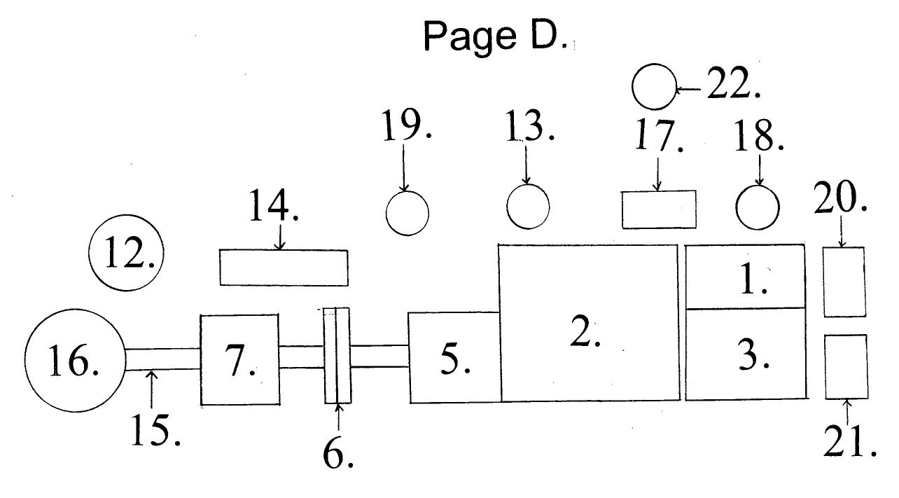

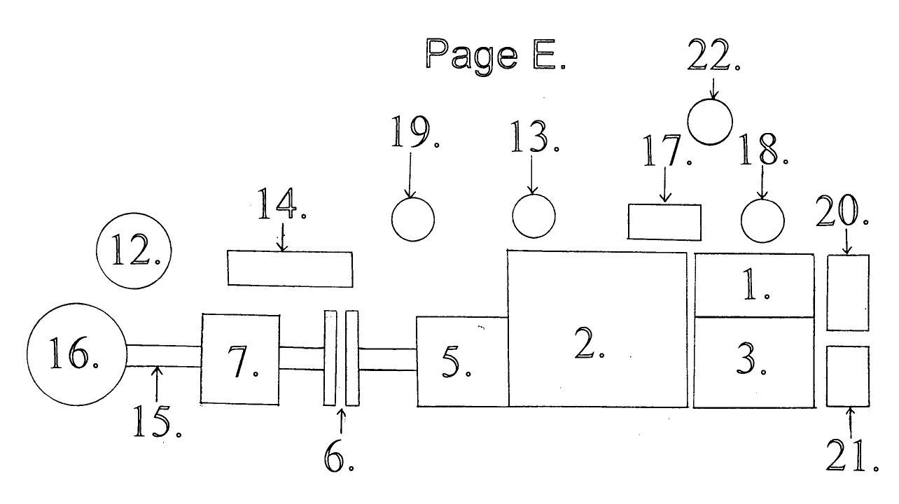

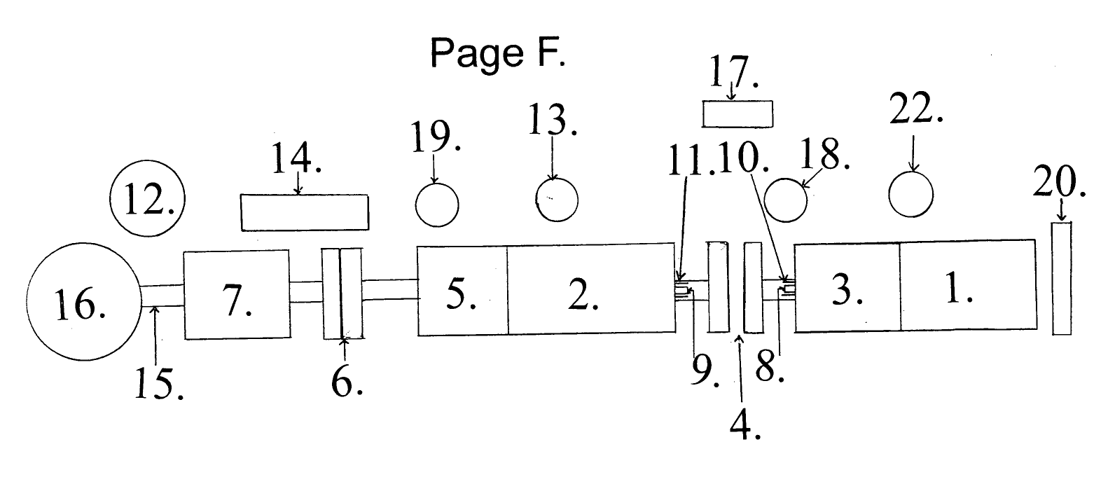

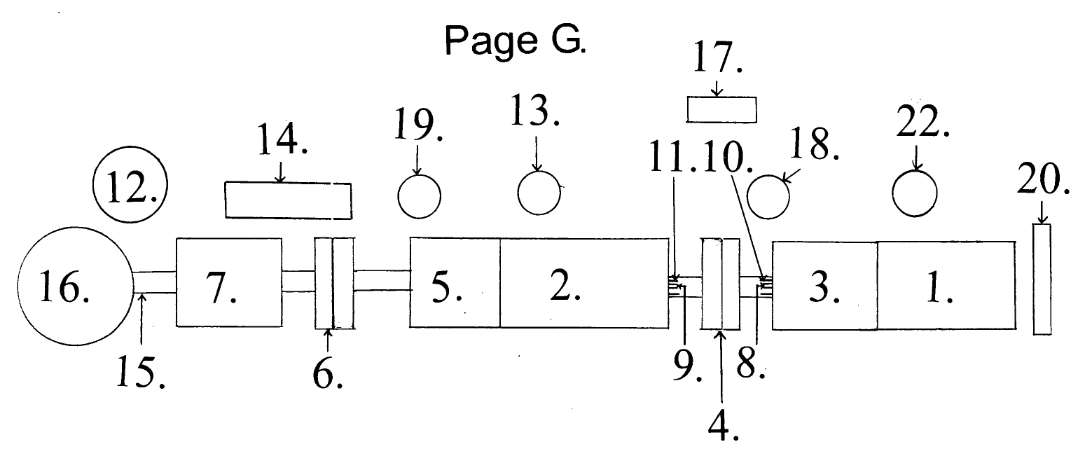

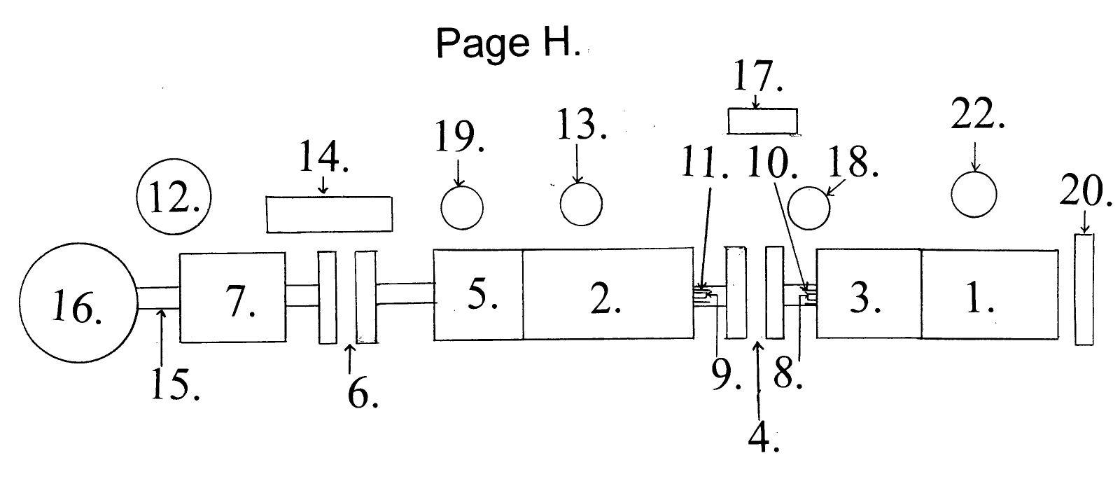

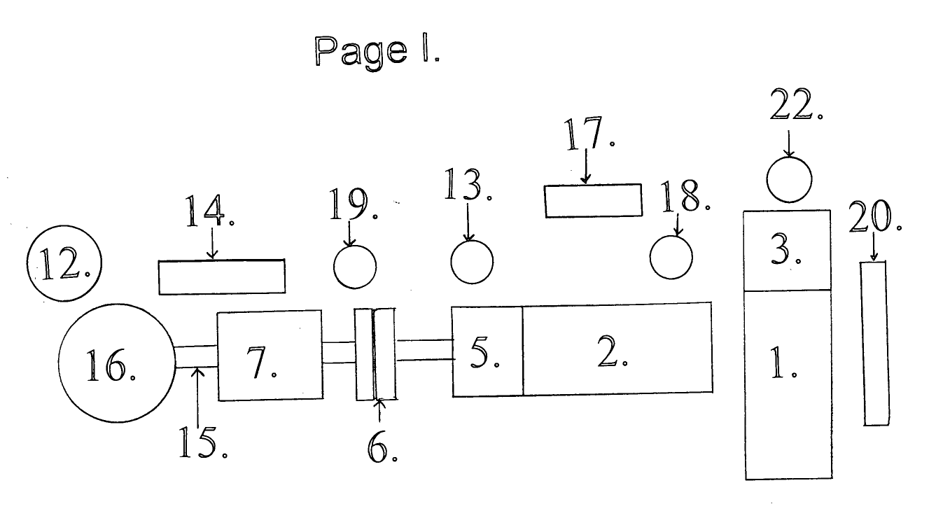

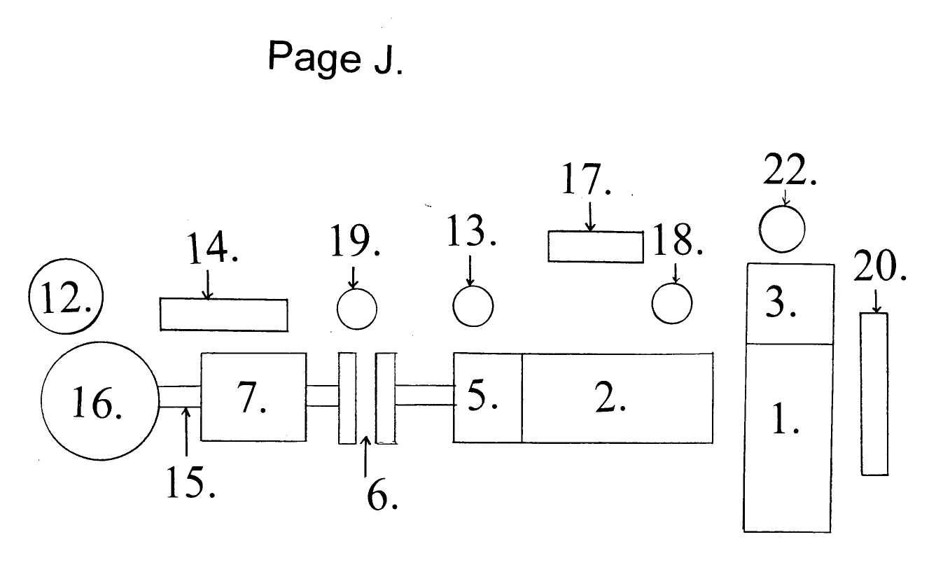

By designing a cost effective no frills hybrid system, allows more trucks to be equipped with this technology and reap the rewards of higher fuel economy. There is minimum research and development funds needed to place this technology on line. This technology can be used in small cars to large vehicles with similar results, increased fuel economy.

### CROSS-REFERENCE TO RELATED APPLICATIONS

This application is related to and claims priory from Provisional Patent Application Ser. No. 60/899,190 Feb. 2, 2007.

### STATEMENT REGARDING FEDERALLY SPONSORED RESEARCH OR DEVELOPMENT

“Not Applicable”

### REFERENCE TO A SEQUENCE LISTING, A TABLE, OR A COMPUTER PROGRAM LISTING

“Not Applicable”

### BACKGROUND OF THE INVENTION

### Field of the Invention

This invention was first conceived to help the heavy hybrid technology reach its fullest potential in fuel economy, at an economical approach. To achieve this goal, I designed an innovating engine and motor/generator layout for maximum power and fuel economy.

The Next Generation Heavy Hybrid Propulsion System III technology is a spin off of my Dual Hybrid Propulsion System and Next Generation Heavy Hybrid Propulsion System II.

This technology uses a novel approach to maximize fuel economy by using two independently operated engines and motor/generators to maximize fuel efficiency without forfeiting sustainable pulling power, not just peak short term power, which is a requirement in the light hybrid technology.

### BRIEF SUMMARY OF THE INVENTION

This invention designed to offer all the advantages of a series hybrid propulsion system then it can offer all the advantages of a parallel hybrid propulsion system. What makes this invention unique is that it uses two completely separate liquid fueled engines. They can operate in unison or independent. One liquid fueled engine is a series/parallel design and the other liquid fueled engine is a parallel design.

### BRIEF DESCRIPTION OF SEVERAL VIEWS OF THE DRAWING

Page letter and drawings:

Page A. Side view of The Next Generation Heavy Hybrid Propulsion System III with engine A (1) and engine B (2) inline with the driveline. Engine A (1) is operating in the series hybrid configuration, automatic clutch (6) is disengaged. Engine B (2) operating in the parallel hybrid configuration and the automatic clutch (6) between the transmission (5) and the motor/generator (7) connected to the driveshaft (15) is engaged.

Page B. Side view of The Next Generation Heavy Hybrid Propulsion System III with engine A (1) and engine B (2) inline with the driveline. Engine A (1) is operating in the parallel hybrid configuration, automatic clutch (6) is engaged. Engine B (2) operating in the parallel hybrid configuration and the automatic clutch (6) between the transmission (5) and the motor/generator (7) connected to the driveshaft (15) is engaged.

Page C. Side view of The Next Generation Heavy Hybrid Propulsion System III with engine A (1) and engine B (2) inline with the driveline. Engine A (1) is operating in the series hybrid configuration, automatic clutch (6) is disengaged. Engine B (2) shut down and the automatic clutch (6) between the transmission (5) and the motor/generator (7) connected to the driveshaft (15) is disengaged.

Page D. Side view of The Next Generation Heavy Hybrid Propulsion System III with engine A (1) sideways and engine B (2) inline with the driveline. Engine A (1) is operating in the series hybrid configuration. Engine B (2) operating in the parallel hybrid configuration and the automatic clutch (6) between the transmission (5) and the motor/generator (7) connected to the driveshaft is engaged

Page E. Side view of The Next Generation Heavy Hybrid Propulsion System III with engine A (1) sideways and engine B (2) inline with the driveline. Engine A (1) is operating in the series hybrid configuration. Engine B (2) shut down and the automatic clutch (6) between the transmission (5) and the motor/generator (7) connected to the driveshaft (15) is disengaged.

Page F. Top view of The Next Generation Heavy Hybrid Propulsion System III with engine A (1) and engine B (2) inline with the driveline. Engine A (1) is operating in the series hybrid configuration, automatic clutch (4) between engines is disengaged. Engine B (2) operating in the parallel hybrid configuration and the automatic clutch (6) between the transmission (5) and the motor/generator (7) connected to the driveshaft (15) is engaged.

Page G. Top view of The Next Generation Heavy Hybrid Propulsion System 111 with engine A (1) and engine B (2) inline with the driveline. Engine A (1) is operating in the parallel hybrid configuration, automatic clutch (4) between engines is engaged. Engine B (2) operating in the parallel hybrid configuration and the automatic clutch (6) between the transmission (5) and the motor/generator (7) connected to the driveshaft (15) is engaged.

Page H. Top view of The Next Generation Heavy Hybrid Propulsion System III with engine A (1) and engine B (2) inline with the driveline. Engine A (1) is operating in the series hybrid configuration, automatic clutch (4) between engines is disengaged. Engine B (2) shut down and the automatic clutch (6) between the transmission and the motor/generator (7) connected to the driveshaft is disengaged.

Page I. Top view of The Next Generation Heavy Hybrid Propulsion System III with engine A (1) sideways and engine B (2) inline with the driveline. Engine A (1) is operating in the series hybrid configuration. Engine B (2) operating in the parallel hybrid configuration and the automatic clutch (6) between the transmission (5) and the motor/generator (7) connected to the driveshaft (15) is engaged.

Page J. Top view of The Next Generation Heavy Hybrid Propulsion System III with engine A (1) sideways and engine B (2) inline with the driveline. Engine A (1) is operating in the series hybrid configuration.

Engine B (2) shut down and the automatic clutch (6) between the transmission (5) and the motor/generator (7) connected to the driveshaft (15) is disengaged.

### NUMBERED COMPONENTS ON DRAWINGS OF THE INVENTION

Components:
1. Engine-A
2. Engine-B
3. Motor/generator connected to engine A.
4. Automatic clutch between engine A and engine B.
5. Transmission
6. Automatic clutch between the transmission and the motor/generator connected to the driveshaft.
7. Motor/generator connected to the driveshaft.
8. Speed sensor on engine A.
9. Speed sensor on engine B.
10. Speed sensor strip on engine A.
11. Speed sensor strip on engine B.
12. Main control box.
13. Throttle position sensor.
14. Electrical storage unit.
15. Driveshaft
16. Differential.
17. Heat exchanger
18. Electric oil pump A.
19. Electric oil pump B.
20. Radiator on engine A
21. Radiator on engine B
22. Manual control hybrid selector

### SUMMARY OF THE INVENTION

This invention relates to electric hybrid vehicles. There are basically three types of electric propulsion systems known for vehicles.

First, there is a pure electric drive vehicle. The pure electric drive vehicle has an electric motor which receives power from a main battery pack via a controller.

The controller, controls the speed of the electric motor. The major disadvantage of a pure electric drive vehicle is that the range is very limited and the vehicle must be stopped and connected to an energy source such as an electrical outlet in order to be recharged.

The second type of electric propulsion system for vehicles is a series hybrid system. There are three major components in a Series system: a generator; an electric motor arranged in series; and an engine powering the generator. Mechanical energy generated by the engine is converted to electrical energy by the generator and is then converted back to mechanical energy by the electric motor.

The main advantage of the Series hybrid is that it is possible to operate the engine at a fixed operating point within its engine speed/torque map. This point can be selected so that the engine functions with the greatest efficiency or produces particularly low emissions. The disadvantage is that it achieves slightly lower fuel economy on the highway compared to the parallel hybrid design.

The third type of electric propulsion systems is the Parallel hybrid system, generally have three component areas. An electrical storage mechanism, such as storage batteries, ultracapacitors, or a combination thereof; an electric drive motor, typically powered by the electrical storage mechanism and used to propel the wheels at least some of the time; and an engine, such as a liquid fueled engine (e.g. internal combustion, stirling engine, or turbine engine) typically used to propel the vehicle directly and/or to recharge the electrical storage mechanism.

In Parallel hybrid systems, the electric drive motor is alternatively driven by mechanically coupling it to the engine.

When coupled, the engine propels the vehicle directly and the electric motor acts as a generator to maintain a desired charge level in the batteries or the ultracapacitor.

While a parallel hybrid system achieves good fuel economy and performance, it must operate in an on and off engine parallel mode. In this mode, the stop-and-go urban driving uses electric power and the engine is used to supplement existing electric system capacity. For long trips, when the battery for the electric motor could be depleted, the vehicle cruises on the small engine and the electric system will provide the peaking power.

This dual series/parallel/mechanical hybrid invention was invented to but not limited to, meet the demands of propelling large trucks/motor vehicles with the greatest fuel economy, maximum peak horsepower and overall versatility. In operation it can resemble a conventional series hybrid propulsion system but it has two completely separate systems capable of working as one large system or as a small system when load requirements are low. With or without assistance from the first and second electrical storage device. Enabling greater fuel economy when driven within the set parameters of the design.

The dual series/parallel hybrid system can also operate in the parallel mode. In operation it resembles a conventional parallel hybrid propulsion systems but it has two completely separate systems capable of working as one large system or a small system when load requirements are low. With or without assistance from the first and/or second electrical storage device. Enabling greater fuel economy when driven within the set parameters of the design.

The dual series/parallel hybrid system can engage one of its liquid fueled engines operate in the series mode and the other liquid fueled engine operate in the parallel mode with or without assistance from the first and/or second electrical storage device.

This invention functions like a fully controllable variable displacement liquid fueled engine in a series/parallel hybrid configuration, using large engine displacement when there is a high power demand and small engine displacement when there is a low power demand, without pumping losses and mechanical fiction losses from other variable displacement systems.

Providing lower fuel consumption than the standard series hybrid design and approaching the fuel economy of a conventional parallel hybrid designs when used in highway applications and displays a major improvements compared to all conventional series and parallel hybrid systems in stop and go-traffic conditions.

This invention helps the heavy hybrid technology reach its fullest potential in fuel economy. Today's single engine hybrid propulsion system lacks the versatility of a dual engine hybrid system. This is especially true when the vehicle is a heavy hybrid design, were there is a high power demand for an extended amount of time.

The single engine hybrid design needs to be sized to meet these high power levels. When the power level demand is decreased once the vehicle is cruising at highway speeds on level roads. The single engine hybrid design would not be operating at the most efficient level due to the large displacement design.

This dual hybrid propulsion system uses a novel approach to maximize fuel economy by using two independently operated liquid fueled engines and one large motor/generator and two small motors/generators.

Also using a partial mechanical kinetic energy storage system to assist the electrical storage device and large motor/generator and small motors/generators for supplemental input torque. This unique mechanical-electrical storage and power assistance technology increases the operational service life of the engines, first and second electrical storage devices and driveline.

This power on demand technology offers series hybrid and parallel hybrid configuration in both engines enabling a unique quad hybrid mode of operation. This arrangement of two small propulsion systems working as one large system. Provides a feasible means of dramatically increasing heavy trucks fuel economy with many off the shelf components for rapid deployment to the market with minimum cost.

### DETAILED DESCRIPTION OF THE INVENTION

This invention incorporates both series and parallel hybrid configurations in one design. They can work independently or together to provide the desired output power and road conditions. The driver can use the manual control hybrid selector (22) to choose the series hybrid mode for city driving, engine A (1) can operate at a high idle in low power demands and a higher engine speed when more power is desired. The main control box (12) will provide the optimum engine speed for adequate power with minimum emissions.

The main control box (12) controls the automatic clutch (4) between engine A (1) and engine B (2) and will have it in the disengaged position. The electrical power produced from the motor/generator (3) connected to engine A (1) will supply the electricity for the motor/generator (7) that is connected to the driveshaft (15).

The main control box (12) controls the automatic clutch (6) that is between the motor/generator (7) and the transmission (5) and will have it in the disengaged position. This allows engine B (2) and the transmission (5) to be completely disengaged from the driveline and engine B (2) will be shut down.

In this series configuration, the vehicle can operate in the zero emission mode as well. This would be for heavy traffic and long waits before moving. In this mode engine A (1) would be shut down and the electrical storage unit (14) will provide the electrical power needed to power the electricity for the motor/generator (7) that is connected to the driveshaft (15).

When the electrical storage unit (14) is depleted to a predetermined level, the main control box (12) will send a signal to the motor/generator (3) connected to engine A (1), this starts engine A (1) and the main control box (12) will provide the optimum engine speed for adequate power with minimum emissions.

This provides electrical output from the motor/generator (3) connected to engine A (1) and this electricity charges the electrical storage unit (14). When the electrical storage unit (14) is fully charged the main control box (12) sends a signal to engine A (1) and it is shut down. This operation consumes the lowest fuel in heavy stop and go conditions.

The main control box (12) and/or the driver can select the parallel hybrid mode of operation. This would be for medium power requirements and maximum fuel economy when cruising down a highway on relatively level roads.

The motor/generator (7) that is connected to the driveshaft (15) can assist engine B (2) for additional short term power requirements. The throttle positioning sensor (13) informs the main control box (12) when there is a need for supplemental power.

The electrical power to the motor/generator (7) is provide from the electrical storage unit, when engine A is shut down.

The main control box (12), controls the automatic clutch (6) between the motor/generator (6) and the transmission (5), and has it in the engaged position. The main control box (12) has the automatic clutch (4) between engine A (1) and engine B (2) to be in the disengaged position.

The driver can also select both series and parallel hybrid configurations with both engine A (1) and engine B (2) operating for greater output power. Engine A (1) will be operating at a high idle speed or operate at a speed that produces the highest power output with the minimum fuel consumption and emissions produced. The main control box (12) has the automatic clutch (4) between engine A (1) and engine B (2) in the disengaged position.

Engine B (2) will be mechanically connected to the driveline with the main control box (12) engaging the automatic clutch (6) between the motor/generator (7) and the transmission (5). The electrical output from the motor/generator (3) connected to engine A (1) powers the motor/generator (7) connected to the driveshaft (15) for the additional power when needed.

To reduce the produced emission from the vehicle accelerating, the following procedure can be preformed, but not limited to:

When the vehicle begins to accelerate, the main control box (12) will engage the lower gear ratio in a but not limited to, two speed differential (16), then increase the operating speed of engine A (1) for maximum electrical output. This electrical output is fed into the motor/generator (7) connected to the driveshaft (15) and it could operate up to its full power rating, if required.

Engine B (2) will be mechanically engaged to the driveline and will assist in the acceleration and start in first gear. When engine B (2) reaches its maximum set speed and needs to shift from 1^{st} to 2^{nd} gear. The motor/generator (7) connected to the driveshaft (15) will stay at but not limited to, full load, if needed to keep the vehicle accelerating during the gear change, once the gear change is completed engine B (2) can assist again in the acceleration process.

This operation can continue up to but not limited to, top gear if needed, then the main control box (12) will then engage the high gear in the two speed differential (16). The transmission (5) will be down shifted either automatically by the main control box (12) or manually by the driver to the appropriate gear ratio, then proceed up to highway speeds.

This operation of the series system functioning at full load, producing minimum emissions. While the parallel system is performing its required gear change, allows the parallel system to produce the least emissions every time it starts to pull the load again. Once the vehicle is up to speed, the throttle position sensor (13) sends a signal to the main control box (12). The main control box (12) can automatically or manually by the driver to shut down the series hybrid system, engine A (1) or reduce its speed to a high idle.

For maximum power, the driver can select both engines A (1) and B (2) to be mechanically connected to the driveline operating in the parallel hybrid configuration. The motor/generator (7) connected to the driveshaft (15) can supply additional power to the driveline for maximum power. The electrical power to the motor/generator (7) will be provided by the electrical storage unit. This technique allows an unique variable displacement engine/parallel hybrid system.

To mechanically engage engine A (1) to engine B (2), the main control box (12) calculates and sets both engines speed with their speed sensors (8-9) and sensor strips (10-11) attached to engine A (1) and engine B (2). When both engines are synchronized and operating at the same speed, the main control box (12) will send a signal to the automatic clutch (4) between engine A (1) and engine B (2) to engage and then both engine A (1) and engine B (1) operate together as if it was one large displacement engine.

The main control box (12) can automatically choose hybrid modes from the information acquired by the throttle positioning sensor (13) and/or road conditions. There is a manual control hybrid selector (22), for the driver to choose hybrid modes as well.

If the engine manufacturers won't allow the use of the automatic clutch (4) to engage and mechanically connect engine A (1) and engine B (2) together due to durability/reliability issues. The automatic clutch (4) can be eliminated between the motor/generator (3) on engine A (1) and engine B (2). Engine A (1) will operate in the series hybrid configuration only. Engine B (2) will still operate in the parallel hybrid configuration only. This enables two engines and two different hybrid capabilities.

Engine A (1) can also be but not limited to, placed sideways compared to the inline engine B (2) and the driveline. Engine A (1) will operate in a series hybrid configuration only. Engine B (2) will still operate in the parallel hybrid configuration only. This engine configuration of one sideways and one in line enables a tight power plant package.

The motor/generator (7) connected to the driveshaft can also provide dynamic braking, to reduce the vehicles speed and converts the vehicles kinetic energy into electrical output. This electrical output is diverted to the electrical storage unit (14). If the electrical storage unit (14) is fully charged the vehicle can then engage the energy wasting, Jake brake.

When the vehicle is on relatively flat roads the main control box (12) and/or the driver can manually select that engine A (1) can be shut down or operate at a high idle. The two engine layout allows that engine A (1) and engine B (2) can operate at different speeds when needed. This enables engine A (1) to operate at a lower speed for maximum fuel economy and a higher speed for maximum power, compared to engine B (2) that is mechanically connected to the driveline.

Engine A (1) and engine B (2) have completely separated cooling systems (20-21) and between the cooling systems (20-21) there is but not limited to, a liquid to liquid heat exchanger. This allows the engine that is shut down to stay at proper temperature from the operating engine.

Each engine can have its own secondary its electric oil pump (18-19), that is controlled by the main control box (12). The main control box (12) will have engine that was chosen to be shut down operate its oil pump in a one minute cycle, every 15 minutes to keep the internal wet and lubed. This operation continues the entire duration the vehicle is operating.

There are two oil burners that can preheat the engines before startup. If the vehicle is started every day at a predetermined time, a timer system can be set to preheat the engine. The oil pumps (18-19) also engage before the engines (1-2) are started to minimize start up wear. When the engine or engines are started, they will be prewarmed without plugging into an electrical source.

The preheated and prelubed engines allow to provide fast startups and place rapidly on line dramatically reducing engine wear. When the engine or engines are started they will produce minimum emissions due to they will be at the proper operating temperature.

The main control box (12) can automatically choose hybrid modes from the information acquired by the throttle positioning sensor (13). There is a manual control hybrid selector (22), for the driver to choose hybrid modes as well.

When the medium duty engines are used but not limited to, accordantly as mentioned above, they can perform reliably in the heavy duty truck class, without displaying durability issues.

What I claim is:

1. A dual engine hybrid whereas; two liquid fuelled engines A-B (1-2), one of the said liquid fuelled engines B (2) is configured in a parallel hybrid and the other liquid fuelled engine A (1) can selected to be configured in a series or parallel hybrid by means of the manual control hybrid selector (22) and/or the main control box (12), whereas the automatic clutch (4) between said engine A (1) and said engine B (2) and at least one but not limited to motor/generator (7), driveshaft/s (15) and differential/s (16) are connected to at least one but not limited to, grounded wheel for propulsion/braking purposes.

2. A dual engine hybrid whereas; the said, two liquid fuelled engines A-B (1-2), one of the said liquid fuelled engines B (2) is configured in a parallel hybrid and the other liquid fuelled engine A (1) can be mechanically connected by means of an automatic clutch (4) to engine B (2) and a manual control hybrid selector (22) and/or the main control box (12) that controls the said automatic clutch (4), for a large displacement, parallel hybrid system.

3. A dual engine hybrid whereas; two liquid fuelled engines A-B (1-2), one of the said liquid fuelled engines B (2) is configured in a parallel hybrid and the other liquid fuelled engine A (1) can be shut down and mechanically disconnected by means of an automatic clutch (4) to engine B (2) and a manual control hybrid selector (22) and/or the main control box (12) that controls the said automatic clutch (4), for a small displacement parallel hybrid system.

4. A dual engine hybrid whereas; said, two liquid fuelled engines A-B (1-2), one of the said liquid fuelled engines B (2) is configured in a parallel hybrid and the other liquid fuelled engine A (1) can be mechanically disconnected by means of an automatic clutch (4) to engine B (2), for a small displacement parallel hybrid, and engine A (1) can stay operating in the series hybrid mode after disconnecting from engine (2), for a small displacement parallel hybrid and a small displacement series hybrid system.

5. A dual engine hybrid whereas; said, two liquid fuelled engines A-B (1-2), one of the said liquid fuelled engines B (2) is disconnected from the driveline by means of an automatic clutch (6) and engine B (1) is shut down, the other liquid fuelled engine A (1) is mechanically disconnected by means of an automatic clutch (4) to engine B (2), engine A (1) can stay operating in any chosen rpm range in the series hybrid mode after disconnecting from engine (2), for a small displacement series hybrid system powers the said motor/generator (7) connected to the driveshaft (15), with or without the assistance from the electrical storage device (14).

6. A dual engine hybrid whereas; said, two liquid fuelled engines A-B (1-2), one of the said liquid fuelled engines B (2) is disconnected from the driveline by
means of an automatic clutch (6) and engine B (1) is shut down, the other liquid fuelled engine A (1) is mechanically disconnected by means of an automatic clutch (4) to engine B (2), engine A (1) is shut down for a zero emission mode, the electrical storage unit (14) powers the said motor/generator (7) connected to the driveshaft (15), the said engine A (1) starts to recharge the said electrical storage unit (14) and stops after the said electrical storage unit (14) is fully charged, by means of the main control box (12).

7. A dual engine hybrid whereas; said engine A (1) starts to recharge the said electrical storage unit (14) when depleted and stops after the said electrical storage unit (14) is fully charged, by means of the main control box (12) for maximum fuel economy, but not limited to, in stop and go traffic conditions.

8. A dual engine hybrid whereas; the said two liquid fuelled engines A-B (1-2), the engine operating in the series only configuration A (1) can be but not limited to, placed sideways in front of the engine operating in the parallel configuration only (B), for a more compact power unit.

9. A dual engine hybrid whereas; the said two liquid fuelled engines (1-2) can operate together or independently at different rpm if needed, but not limited to, also the said two liquid fuelled engines (1-2) can be displacement sized equally or in any displacement size, if required.
